(19) United States
(12) Patent Application Publication
(10) Pub. No.: US 2026/0329318 A1
(43) Pub. Date: Oct. 22, 2026

(54) STRESS-FREE POWER-DOWN CIRCUIT IMPLEMENTATION USING HIGH VOLTAGE TOLERANT LEVEL SHIFTERS

(71) Applicant: Advanced Micro Devices, Inc., Santa Clara, CA (US)

(72) Inventors: Mohana Murali Kishan Sureddi, Visakhapatnam (IN); Vara Kishore Naidu Vechalapu, Vizianagram (IN); Joseph Jose Vettickatt, Kottayam (IN); Venkata Krishna Reddy Mudimela, Bangalore (IN); Girish Anathahalli Singrigowda, Bengaluru (IN)

(21) Appl. No.: 19/182,064

(22) Filed: Apr. 17, 2025

(51) Int. Cl. G05F 1/565; G05F 1/575; H03K 19/0185

(52) U.S. Cl. CPC G05F 1/565; G05F 1/575; H03K 19/018521

(57) ABSTRACT

A system includes a level shifter configured to generate a first signal having a first operating voltage and a second signal having a second operating voltage based on a control signal and a reference voltage generator coupled to the level shifter. The reference voltage generator is configured to generate a third signal having a third operating voltage. The system further includes a low-dropout regulator coupled to the level shifter and the reference voltage generator. The low-dropout regulator includes an output stage. The output stage includes a first transistor configured to receive the first signal from the level shifter, a second transistor configured to receive the second signal from the level shifter, and a third transistor configured to receive the third signal from the reference voltage generator. The second transistor and the third transistor act as cascode transistors.

### BACKGROUND

Power management is an aspect of modern integrated circuits, particularly as semiconductor process technologies continue to advance toward smaller nodes. In many applications, circuits must interface between different voltage domains while maintaining reliable operation and minimizing power consumption. Power-down functionality is useful for extending battery life in portable devices by disabling unused circuit blocks when they are not needed.

As semiconductor manufacturing processes scale to smaller geometries, the maximum allowable voltage across device terminals continues to decrease due to reliability constraints. This creates challenges for designing power management circuits that must operate with higher supply voltages while using only core devices available in advanced process nodes. Traditional approaches that worked well in older technology nodes become increasingly difficult to implement as device voltage tolerances decrease with each new process generation.

### BRIEF DESCRIPTION OF THE DRAWINGS

For a more complete understanding of the present disclosure, and the advantages thereof, reference is now made to the following descriptions taken in conjunction with the accompanying drawings.

FIG. 1 illustrates a block diagram of a low-dropout voltage regulator system, in accordance with some implementations.

FIG. 2 illustrates a schematic of a low-dropout voltage regulator, in accordance with some implementations.

FIG. 3 illustrates a process of operating a bias block of a low-dropout voltage regulator in active and power-down modes, in accordance with some implementations.

FIG. 4 illustrates a process of operating an error amplifier block of a low-dropout voltage regulator in active and power-down modes, in accordance with some implementations.

FIG. 5 illustrates a process of operating a pass transistor block of a low-dropout voltage regulator in active and power-down modes, in accordance with some implementations.

FIG. 6 illustrates a schematic of a level shifter, in accordance with some implementations.

FIG. 7 illustrates a schematic of a reference voltage generator, in accordance with some implementations.

FIG. 8 illustrates a table of delay results for a level shifter, in accordance with some implementations.

FIG. 9 illustrates a table of power consumption results for a low-dropout voltage regulator system, in accordance with some implementations.

FIG. 10 illustrates a table of reliability results for a low-dropout voltage regulator system, in accordance with some implementations.

FIG. 11 illustrates a flowchart of a method for operating a low-dropout voltage regulator in active mode, in accordance with some implementations.

FIG. 12 illustrates a flowchart of a method for operating a low-dropout voltage regulator in power-down mode, in accordance with some implementations.

Corresponding numerals and symbols in the different figures generally refer to corresponding parts unless otherwise indicated. The figures are drawn to clearly illustrate the relevant aspects of the implementations and are not necessarily drawn to scale. The edges of features drawn in the figures do not necessarily indicate the termination of the extent of the feature.

### DETAILED DESCRIPTION OF ILLUSTRATIVE IMPLEMENTATIONS

The making and using of various implementations are discussed in detail below. It should be appreciated, however, that the various implementations described herein are applicable in a wide variety of specific contexts. The specific implementations discussed are merely illustrative of specific ways to make and use various implementations, and should not be construed in a limited scope.

Reference to “an implementation,” “one implementation,” “an embodiment,” or “one embodiment” in the framework of the present description is intended to indicate that a particular configuration, structure, or characteristic described in relation to the implementation/embodiment is included in at least one implementation/embodiment. Hence, phrases such as “in one implementation” or “in one embodiment” that may be present in one or more points of the present description do not necessarily refer to one and the same implementation/embodiment. Moreover, particular conformations, structures, or characteristics may be combined in any adequate way in one or more implementations/embodiments. The references used herein are provided merely for convenience and hence do not define the extent of protection or the scope of the implementations/embodiments.

In various implementations, power management circuits are provided that enable safe operation of low-voltage transistors in higher voltage environments while maintaining efficient power control. As semiconductor manufacturing processes advance toward smaller technology nodes, the maximum voltage that devices (e.g., thin-oxide transistors) can safely handle decreases. In modern integrated circuits fabricated with advanced processes, thin-oxide transistors may only tolerate voltages of approximately 0.96 volts (+10% of 0.8 V) between any two terminals before experiencing stress that can lead to reliability issues or device failure. This creates a significant challenge when these same devices need to operate in systems with higher supply voltages, such as 1.8 volts. Using the traditional power-down techniques for analog circuits operating at supply voltages as high as 1.8 V, the devices (e.g., thin-oxide transistors) may see voltages greater than 0.96 V across their terminals and will be stressed.

The present disclosure provides power-down circuitry implementations in analog circuits. Various implementations are described with reference to low-dropout (LDO) voltage regulator systems. However, power-down circuitry implementations described herein may be also applied to other analog circuits. The proposed design addresses the challenges associated with stress-free power-down circuit implementations and achieving efficient power management in analog circuits.

The power-down circuit implementations described herein address this voltage tolerance challenge by using specialized level shifters that dynamically adjust the operating voltages applied to different parts of the circuit. In one or more implementations, these level shifters generate intermediate voltage levels that ensure no transistor experiences a voltage difference exceeding its stress limit, even when the overall system operates from a higher supply voltage. This approach allows thin-oxide transistors designed for lower voltages to safely function in higher voltage domains without requiring special high-voltage transistors that would increase manufacturing costs.

In an implementation, a low-dropout voltage regulator system includes a level shifter that generates appropriate control signals to manage the voltages across transistors in both active and power-down modes. The level shifter creates a set of controlled intermediate voltages that are strategically applied to different transistors in the circuit. During active mode, these voltages enable normal operation of the regulator while maintaining safe voltage levels across all devices. When transitioning to power-down mode, the level shifter adjusts these voltages to ensure power consumption is minimized while still protecting all transistors from excessive voltage stress.

Various power-down circuit implementations of the present disclosure provide several advantages over conventional approaches. First, they enable the use of thin-oxide transistors throughout the design, eliminating the need for special high-voltage devices and reducing manufacturing costs. In some cases, a separate voltage regulator may be unnecessary, which may advantageously simplify the overall system design and reduce component count. Second, various implementations achieve effective power management by completely shutting down current paths during power-down mode while maintaining stress-free conditions for all devices. Third, various implementations operate reliably across a wide range of process variations, supply voltages, and temperatures.

Various power-down circuit implementations of the present disclosure may be used in future technology nodes, which can reduce redesign time and associated costs as semiconductor manufacturing advances. Some implementations are advantageous for designs in lower technology nodes operating on supplies greater than 1.5 V, where some traditional power-down techniques may cause device stress. Additionally, various power-down circuit implementations of the present disclosure reduce or eliminate the need for complex power-up sequencing, streamlining the power management process. These implementations are particularly valuable for portable electronic devices where battery life is critical and where circuits must frequently transition between active and power-down states to conserve energy.

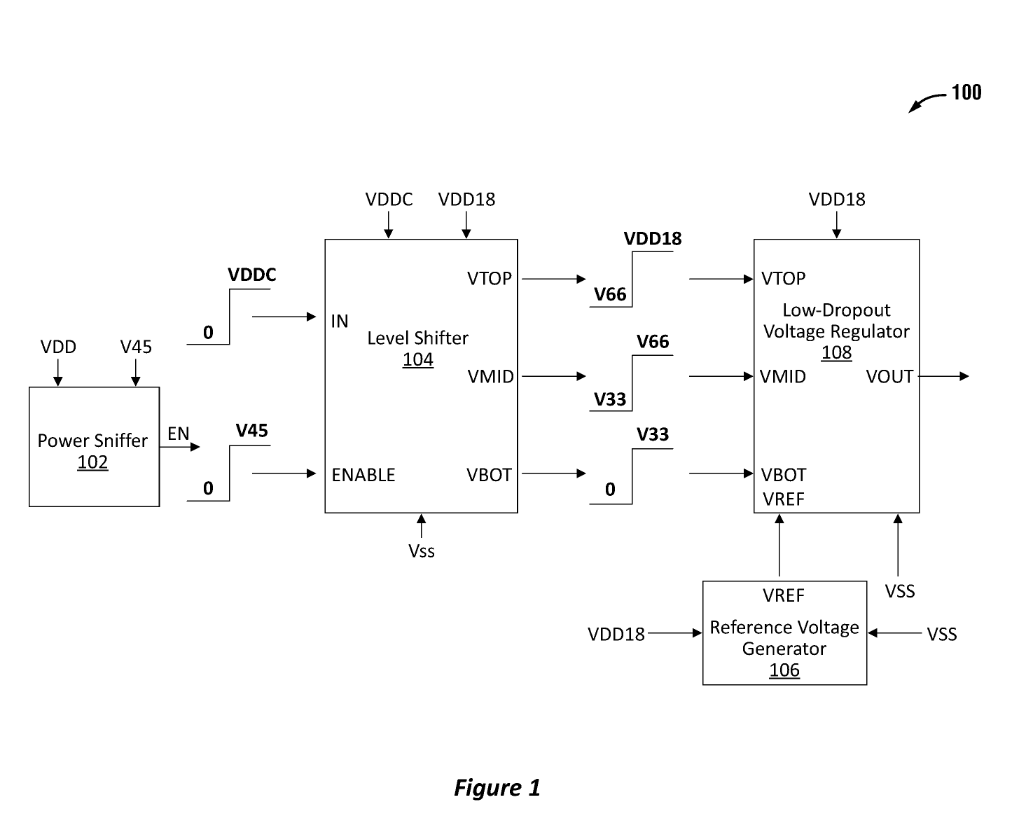

FIG. 1 illustrates a block diagram of a low-dropout (LDO) voltage regulator system 100, in accordance with some implementations. The LDO voltage regulator system 100 comprises a power sniffer 102, a level shifter 104, a reference voltage generator 106, and a low-dropout (LDO) voltage regulator 108. The power sniffer 102 is biased at voltages VDD18 and V45 and is configured to generate an enable signal. The power sniffer 102 is further configured to provide the enable signal to the level shifter 104. In an implementation, VDD18 is a power supply voltage of about 1.8 V, and V45 is 0.45*VDD18 (e.g., about 0.81 V). In other implementations, the power supply voltage may be in a range from 1.62 V to 1.98 V. The power sniffer 102 is configured to operate in active and power-down (PD) modes. In the active mode, the power sniffer 102 is configured to generate a first enable signal (e.g., logic high). The first enable signal may have an enable voltage VEN that is set to V45. In the PD mode, the power sniffer 102 is configured to generate a second enable signal (e.g., logic low). The second enable signal may have the enable voltage VEN that is set to zero.

The level shifter 104 is biased by voltages VDDC, VDD18, and VSS, and is configured to generate a signal having a top voltage VTOP, a signal having a middle voltage VMID, and a signal having a bottom voltage VBOT based on the enable signal having the enable voltage VEN and an IN signal having an IN voltage VIN in VDDC domain. The level shifter 104 is also configured to generate a signal having a top voltage VTOP_b, a signal having a middle voltage VMID_b, and a signal having a bottom voltage VBOT_b. In an implementation, VDDC is set to 0.96V. In an implementation, VSS is set to zero. V33 is 0.33*VDD18 (e.g., about 0.6 V) and V66 is 0.66*VDD18 (e.g., about 1.2 V). The top voltage VTOP, the middle voltage VMID, and the bottom voltage VBOT may be also referred to as operating voltages and are provided to the LDO voltage regulator 108 from the level shifter 104.

The level shifter 104 is configured to operate in active and PD modes without voltage-stress. In the active mode, the level shifter 104 is configured to receive the IN signal having the IN voltage VIN that is set to VDDC and the enable signal having the enable voltage VEN that is set to V45, and generate a signal having the top voltage VTOP that is set to V66, a signal having the middle voltage VMID that is set to V33, and a signal having the bottom voltage VBOT that is set to zero.

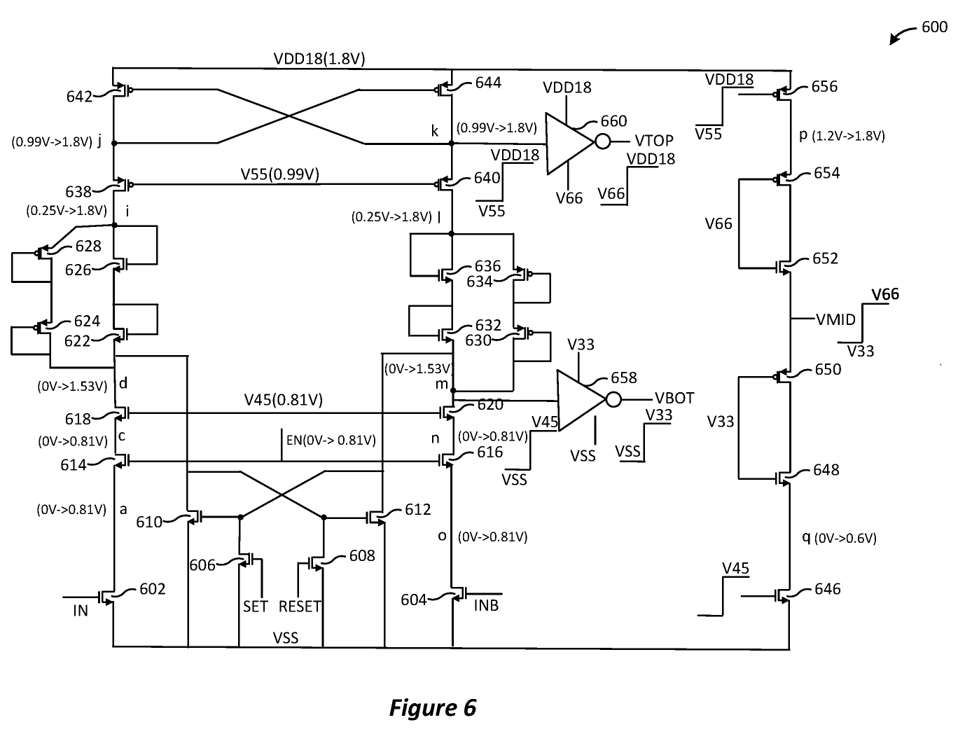

In the PD mode, the level shifter 104 is configured to receive the IN signal having the IN voltage VIN that is set to zero and the enable signal having the enable voltage VEN that is set to zero and generate a signal having the top voltage VTOP that is set to VDD18, a signal having the middle voltage VMID that is set to V66, and the signal having the bottom voltage VBOT that is set to V33. The level shifter 104 is configured to provide the signal having the top voltage VTOP, the signal having the middle voltage VMID, and the signal having the bottom voltage VBOT to the LDO voltage regulator 108. In some implementations, the level shifter 104 may be implemented by a level shifter 600 described below with reference to FIG. 6.

The reference voltage generator 106 is biased by voltages VDD18 and VSS, and is configured to generate a reference signal having a reference voltage VREF. In some implementations, the reference voltage generator 106 is configured to generate multiple reference signals having different reference voltages VREFs. In an implementation, the reference voltage generator 106 is configured to generate a first reference signal having a reference voltage VREF that is set to V33 and a second reference signal having a reference voltage VREF that is set to V66. The reference voltage generator 106 provides reference signals to the level shifter 104 and the LDO voltage regulator 108.

The LDO voltage regulator 108 is biased by voltages VDD18, VSS, and VREF (e.g., V33 or V66), and is configured to generate a signal having an output voltage VOUT based on a signal having the top voltage VTOP, a signal having the middle voltage VMID, and a signal having the bottom voltage VBOT received from the level shifter 104. The level shifter 104 is configured to operate in active and PD modes.

In the active mode, the LDO voltage regulator 108 is configured to receive a signal having the top voltage VTOP that is set to VDD18, a signal having the middle voltage VMID that is set to V33, and a signal having the bottom voltage VBOT that is set to zero, and generate a signal having the output voltage VOUT. In an implementation, VOUT is set to 1.6 V. In some implementations, VOUT is based on VREF. In the active mode, the LDO voltage regulator 108 is also configured to receive a signal having the top voltage VTOP_b that is set to V66, a signal having the middle voltage VMID_b that is set to V66, and a signal having the bottom voltage VBOT_b that is set to V33.

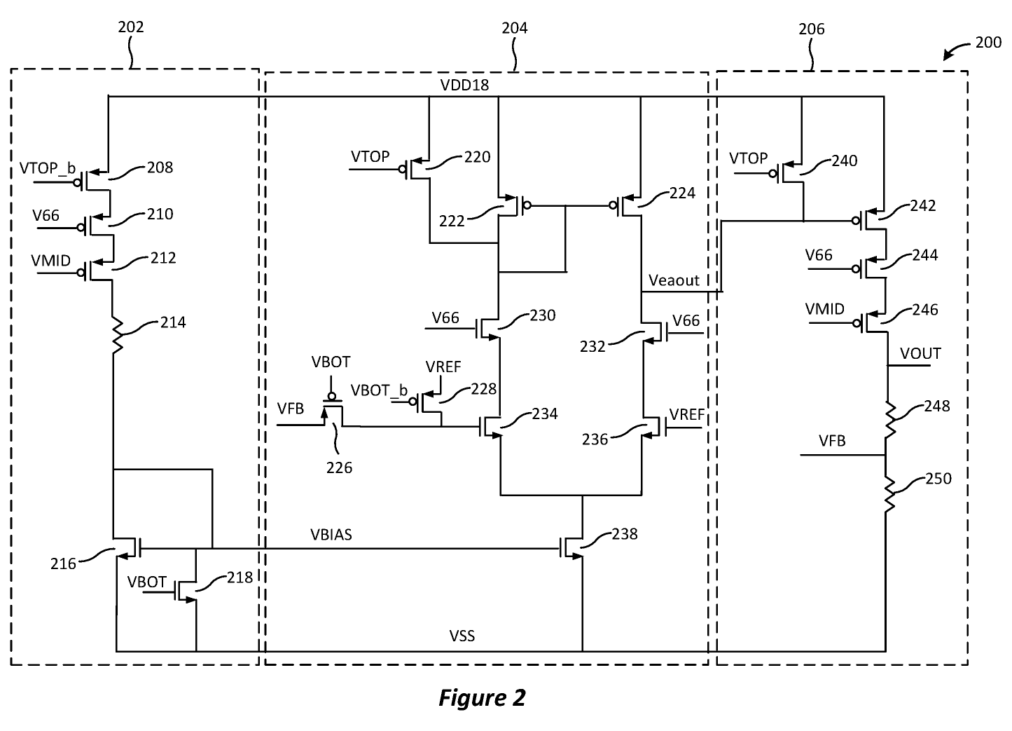

In the PD mode, the LDO voltage regulator 108 is configured to receive a signal having the top voltage VTOP that is set to V66, a signal having the middle voltage VMID that is set to V66, and a signal having the bottom voltage VBOT that is set to V33, and generate a signal having the output voltage VOUT. In an implementation, VOUT is set to zero. In the active mode, the LDO voltage regulator 108 is also configured to receive a signal having the top voltage VTOP_b that is set to VDD18, a signal having the middle voltage VMID_b that is set to V33, and a signal having the bottom voltage VBOT_b that is set to zero. In some implementations, the LDO voltage regulator 108 may be implemented by an LDO voltage regulator 200 described below with reference to FIG. 2.

FIG. 2 illustrates a schematic of a low-dropout (LDO) voltage regulator 200, in accordance with some implementations. In an implementation, the LDO voltage regulator 108 of the LDO voltage regulator system 100 (see FIG. 1) is implemented by the LDO voltage regulator 200. In the illustrated implementation, the LDO voltage regulator 200 comprises MOS transistors. In other implementations, the LDO voltage regulator 200 may comprise transistors of any suitable type. The LDO voltage regulator 200 comprises a bias block 202, an error amplifier block 204 and a pass transistor block 206. The pass transistor block 206 may be also referred to as an output block or an output stage.

The bias block 202 comprises PMOS transistor 208 that acts as a PMOS switch, PMOS transistors 210 and 212 that act as cascode transistors when the LDO voltage regulator 200 is in active mode, and diode-connected NMOS transistor 216 is a part of a current mirror that includes NMOS transistors 216 and 218. The NMOS transistor 218 is used to pull the node VBIAS to ground during the PD mode. A source of the PMOS transistor 208 is connected to the power supply node, which is set to VDD18. A source of the NMOS transistor 216 and a source of the NMOS transistor 218 and are connected to the ground node that is set to VSS. The bias block 202 further comprises a resistor 214 connected between a drain of the PMOS transistor 212 and a drain of the NMOS transistor 216.

A gate of PMOS transistor 208 is configured to receive a signal having a top voltage VTOP_b. A gate of PMOS transistor 210 is biased by voltage V66. A gate of PMOS transistor 212 is configured to receive a signal having the middle voltage VMID. A gate of NMOS transistor 218 is configured to receive a signal having the bottom voltage VBOT. The bias block 202 is configured to generate a signal having bias voltage VBIAS and provides the signal to the error amplifier block 204. Gates of PMOS transistors 208, 210 and 212, and NMOS transistor 218 may be also referred to as control nodes.

The error amplifier block 204 comprises a differential pair (i.e., NMOS transistors 234 and 236) and NMOS transistor 238 that acts as a current source to the differential pair. The error amplifier block 204 further comprises PMOS transistors 222 and 224 are a current mirror, NMOS transistors 230 and 232 act as cascode transistors, PMOS transistor 220 that is used to deactivate the current mirror during PD mode. The error amplifier block 204 further comprises PMOS transistor 226 that acts a pass transistor switch that couples a gate of the NMOS transistor 234 to a feedback voltage VFB during active mode and PMOS transistor 228 that couples the gate of the NMOS transistor 234 to a voltage VREF during the PD mode. Sources of PMOS transistors 220, 222 and 224 are coupled to the power supply node that is set to VDD18. A source of the NMOS transistor 238 is couple to the ground node that is set to VSS.

A gate of PMOS transistor 220 is configured to receive a signal having the top voltage VTOP. A gate of PMOS transistor 226 is configured to receive a signal having the bottom voltage VBOT. A source of PMOS transistor 226 is set to the feedback voltage VFB. A gate of PMOS transistor 228 is configured to receive a signal having a bottom_b voltage VBOT_b. A source of PMOS transistor 228 is set to the reference voltage VREF. A gate of NMOS transistor 230 and a gate of NMOS transistor 232 are set to V66. A gate of NMOS transistor 236 is set to the reference voltage VREF. The error amplifier block 204 is further configured to generate a signal having an error amplifier out voltage VEAOUT and provides the signal having the error amplifier out voltage VEAOUT to the pass transistor block 206. Gates of PMOS transistors 220-228 and NMOS transistors 230-238 may be also referred to as control nodes.

The pass transistor block 206 acts as the output stage of the LDO voltage regulator 200. The pass transistor block 206 comprises PMOS transistor 242 that acts a pass transistor having its gate coupled to the output of the error amplifier block 204, PMOS transistors 244 and 246 act as cascode transistors during the active mode of the LDO voltage regulator 200 and resistors 248 and 250 that form the feedback network on the LDO regulator. During operation, when the NMOS transistor 234 is set to VFB, the closed loop causes the voltage VFB to be about the voltage VREF. Output voltage VOUT can be set according to the ratio of resistors 248 to 250. A source of PMOS transistor 240 is coupled to the power supply node that is set to VDD18. A gate of PMOS transistor 240 is configured to receive a signal having the top voltage VTOP. A gate of PMOS transistor 246 is configured to receive a signal having the middle voltage VMID. In some implementations, a resistance of the resistor 250 is twice a resistance of the resistor 248. The pass transistor block 206 is further configured to generate an output signal having an output voltage VOUT. Gates of PMOS transistors 240-246 may be also referred to as control nodes.

In the implementation illustrated in FIG. 2, each of the transistors 208-246 is configured as a single transistor. In other implementations, each of the transistors 208-246 may be configured as a stack of transistors. In such implementations, the stack of transistors may be connected in series or in parallel.

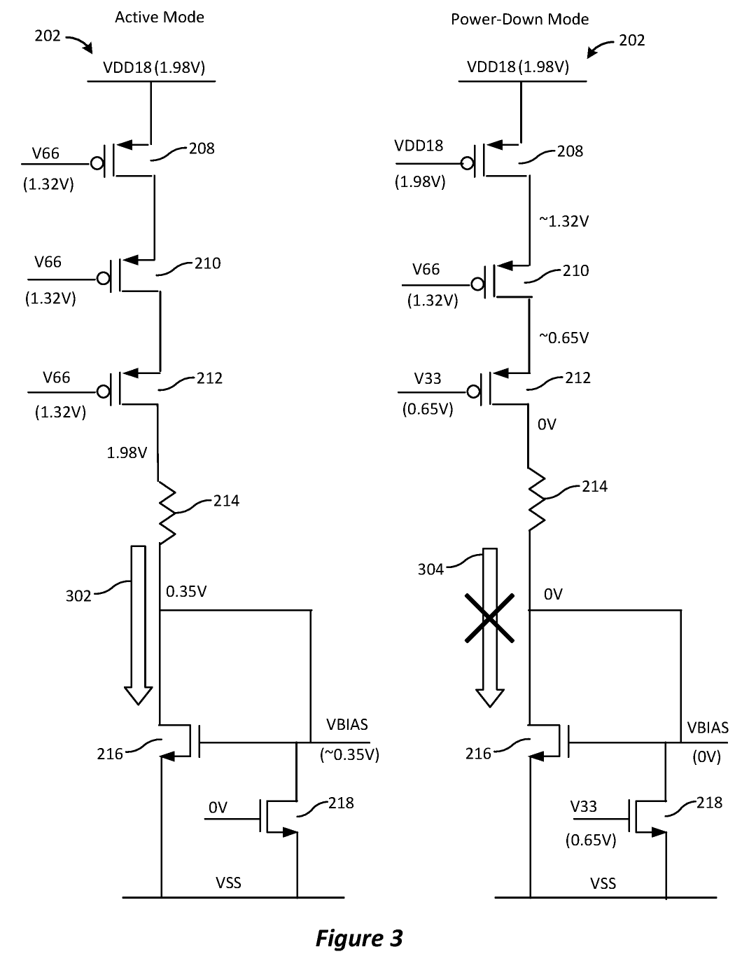

FIG. 3 illustrates a process of operating the bias block 202 of the LDO voltage regulator 200 (see FIG. 2) in active and PD modes, in accordance with some implementations. In active mode, the gate of PMOS transistor 208 receives a signal having the top voltage VTOP_b that is set to V66, the gate of PMOS transistor 210 is biased by V66, the gate of PMOS transistor 212 receives a signal having the middle voltage VMID that is set to V66, and the gate of NMOS transistor 218 receives a signal having the bottom voltage VBOT that is set to zero, allowing a current flow through the bias block 202 as indicated by an arrow 302. The bias block 202 is further configured to generate a signal having the bias voltage VBIAS that is set to about 0.35 V.

In PD mode, the gate of PMOS transistor 208 receives a signal having the top voltage VTOP_b that is set to VDD18, turning it OFF and cutting a current path through the bias block 202 as indicated by a crossed-out arrow 304. The gate of PMOS transistor 210 remains biased at V66. The gate of PMOS transistor 212 receives a signal having the middle voltage VMID that is set to V33 and the gate of NMOS transistor 218 receives a signal having the bottom voltage VBOT that is set to V33. The bias block 202 is further configured to generate a signal having the bias voltage VBIAS that is set to zero. This configuration ensures that even in the PD mode, no device experiences a voltage difference greater than 0.96 V between any of its terminals. This arrangement effectively reduces or eliminates static current consumption during power-down while maintaining stress-free conditions for all devices.

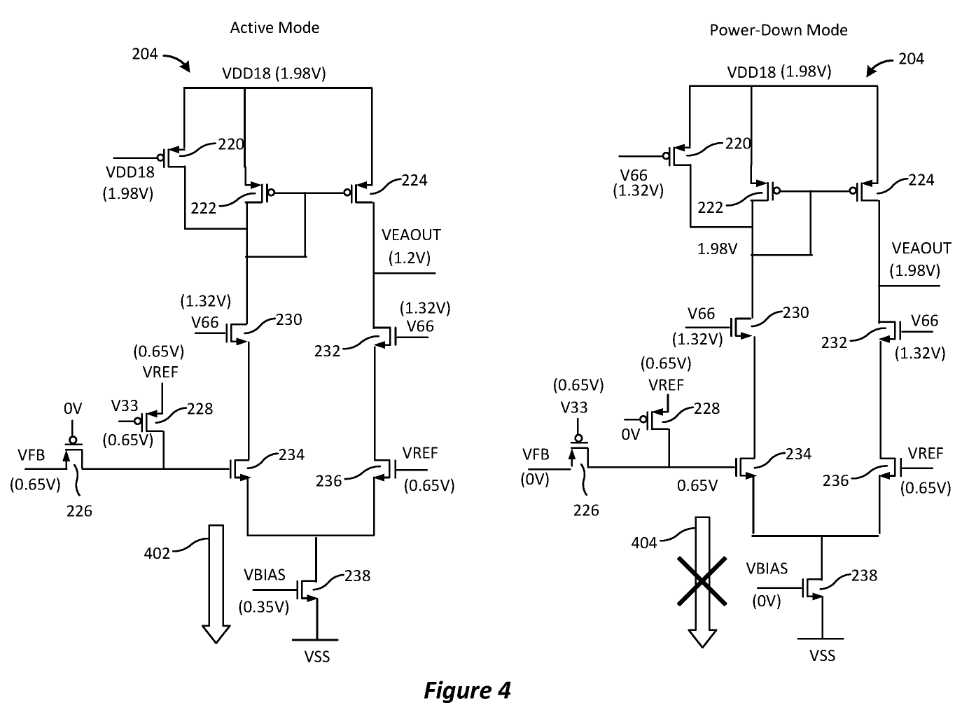

FIG. 4 illustrates a process of operating the error amplifier block 204 of the LDO voltage regulator 200 (see FIG. 2) in active and PD modes, in accordance with some implementations. In active mode, the error amplifier block 204 functions as a differential amplifier. In active mode, the gate of PMOS transistor 220 receives a signal having the top voltage VTOP that is set to VDD18, the gate of PMOS transistor 226 receives a signal having the bottom voltage VBOT that is set to zero, the source of PMOS transistor 226 is biased at VFB, the gate of PMOS transistor 228 receives a signal having the bottom_b voltage VBOT_b that is set to V33, the source of PMOS transistor 228 is biased at VREF, the gates of NMOS transistors 230 and 232 are biased at V66, the gate of NMOS transistor 236 is biased at VREF, and the gate of NMOS transistor 238 receives a signal having the bias voltage VBIAS, and generates a signal having the error amplifier out voltage VEAOUT that is set to 1.2 V. In the illustrated implementation, both VFB and VREF are set to 0.65 V and VBIAS is set to 0.35 V. In the active mode, current flows through the error amplifier block 204 as indicated by an arrow 402. This allows proper operation of error amplifier block 204 while maintaining safe voltage levels across all devices.

In PD mode, the gate of PMOS transistor 220 receives a signal having the top voltage VTOP that is set to V66, the gate of PMOS transistor 226 receives a signal having the bottom voltage VBOT that is set to V33, the source of PMOS transistor 226 is biased at VFB, the gate of PMOS transistor 228 receives a signal having the bottom_b voltage VBOT_b that is set to zero, the source of PMOS transistor 228 is biased at VREF, the gates of NMOS transistors 230 and 232 are biased at V66, the gate of NMOS transistor 236 is biased at VREF, and the gate of NMOS transistor 238 receives a signal having the bias voltage VBIAS, and generates a signal having the error amplifier out voltage VEAOUT that is set to 1.98 V. In the illustrated implementation, VFB is set to zero, VREF is set to 0.65 V, and VBIAS is set to zero. In PD mode, the NMOS transistor 238 is turned OFF, cutting a current flow through the error amplifier block 204 as indicated by a crossed-out arrow 404. This configuration effectively disables the error amplifier block 204 while ensuring that no transistor sees a voltage difference greater than 0.96 V between any of its terminals, thus achieving a stress-free or reduced-stress power-down state.

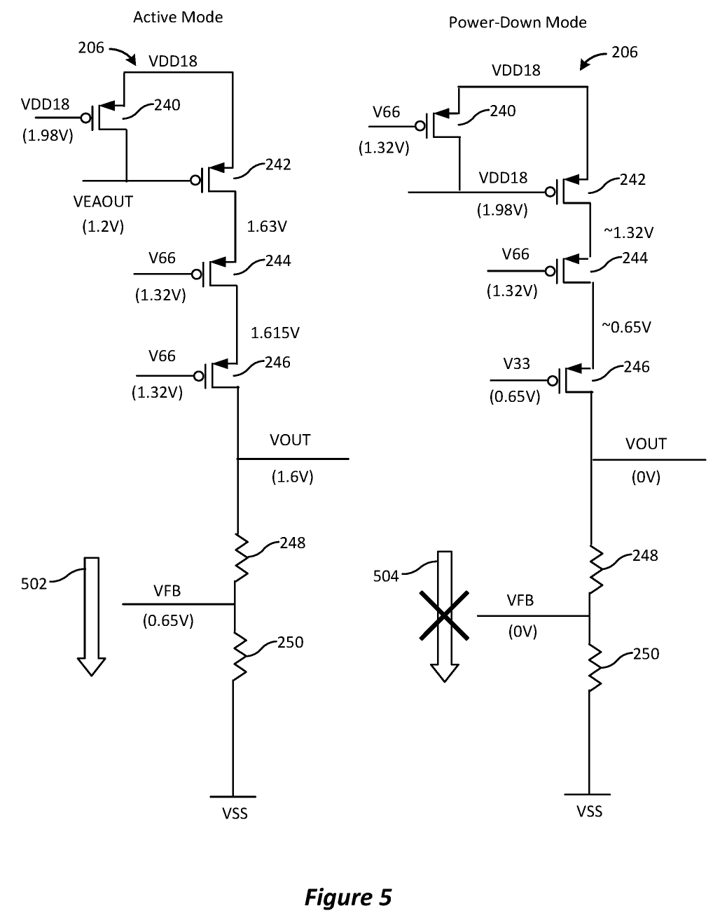

FIG. 5 illustrates a process of operating the pass transistor block 206 of the LDO voltage regulator 200 (see FIG. 2) in active and power-down modes, in accordance with some implementations. In active mode, the gate of PMOS transistor 240 receives a signal having the top voltage VTOP that is set to VDD18 and turns OFF PMOS transistor 240, the gate of PMOS transistor 242 receives a signal having the output voltage VEAOUT from the error amplifier block 204 that controls the amount of current flowing through the PMOS transistor 242 transistor, the gate of PMOS transistor 244 is biased at V66, and the gate of PMOS transistor 246 receives a signal having the middle voltage VMID that is set to V66. In the active mode, current flows through the pass transistor block 206 as indicated by an arrow 502. The pass transistor block 206 is further configured to generate a signal having the output voltage VOUT that is set to 1.6 V. This allows proper operation of the pass transistor block 206 while maintaining safe voltage levels across all devices.

In PD mode, the gate of PMOS transistor 240 receives a signal having the top voltage VTOP that is set to V66, pulling the gate of PMOS transistor 242 to the supply voltage VDD18, effectively turning OFF PMOS transistor 242 and cutting a current flow through the pass transistor block 206 as indicated by a crossed-out arrow 504. The gate of PMOS transistor 244 remains biased at V66. The gate of PMOS transistor 244 receives a signal having the middle voltage VMID that is set to V33. The pass transistor block 206 is further configured to generate a signal having the output voltage VOUT that is set to zero. This configuration ensures that even when powered down, no device in sees a voltage difference greater than 0.96 V between any of its terminals. The cascoded structure and dynamic biasing allow the pass transistor block 206 to achieve a stress-free or reduced-stress state in the power-down mode while being capable of handling the full 1.8 V+10% supply voltage in the active mode.

FIG. 6 illustrates a schematic of a level shifter 600, in accordance with some implementations. In an implementation, the level shifter 104 of the LDO voltage regulator system 100 (see FIG. 1) is implemented by the level shifter 600. In the illustrated implementation, the level shifter 600 comprises MOS transistors. In other implementations, the level shifter 600 may comprise transistors of any suitable type. The level shifter 600 is configured to generate a signal having the top voltage VTOP, a signal having the middle voltage VMID, and a signal having the bottom voltage VBOT, such that voltages of the signals change between active and PD modes. The level shifter 600 is further configured to provide a signal having the top voltage VTOP, a signal having the middle voltage VMID, and a signal having the bottom voltage VBOT to an LDO regulator (e.g., LDO voltage regulators 108 and 200 of FIGS. 1 and 2, respectively).

In active mode, the level shifter 600 receives a first enable (EN) signal and generates a signal having the top voltage VTOP that is set to VDD18, a signal having the middle voltage VMID that is set to V33, and a signal having the bottom voltage VBOT that is set to zero. In active mode, the level shifter 600 further generates a signal having the top voltage VTOP_b that is set to VD66, a signal having the middle voltage VMID_b that is set to V66, and a signal having the bottom voltage VBOT_b that is set to V33. In PD mode, the level shifter 600 receives a second EN signal different from the first EN signal and generates a signal having the top voltage VTOP that is set to V66, a signal having the middle voltage VMID that is set to V66, and a signal having the bottom voltage VBOT that is set to V33. In PD mode, the level shifter 600 further generates a signal having the top voltage VTOP_b that is set to VDD18, a signal having the middle voltage VMID_b that is set to V33, and a signal having the bottom voltage VBOT_b that is set to zero. These voltage levels ensure that no device experiences a voltage difference greater than 0.96 V between any of its terminals. The level shifter 600 enables stress-free operation of the thin-oxide devices used throughout the LDO, both in active and PD modes, despite the presence of a 1.8 V supply voltage. The voltage levels correspond to the LDO voltage regulator system 100 when the LDO voltage regulator 108 (see FIG. 1) is implemented by the LDO voltage regulator 200 (see FIG. 2) and the level shifter 104 (see FIG. 1) is implemented by the level shifter 600 (see FIG. 6). In other implementations, the voltage levels depend on the implementation of the level shifter 104 and the LDO voltage regulator 108, such as characteristics of the individual devices (e.g., transistors) used to form the level shifter 104 and the LDO voltage regulator 108. These characteristics (and the resulting voltage levels) will vary depending on a process technology used to form the individual devices.

In some implementations, the level shifter 600 comprises cascoded PMOS transistors 638 and 640, cascoded NMOS transistors 614 and 616, cascoded NMOS transistors 618 and 620, pull-up PMOS transistors 642 and 644, pull-down NMOS transistors 602 and 604, diode-connected PMOS transistors 622-628, diode-connected NMOS transistors 630-636, and inverters 658 and 660.

The diode-connected PMOS transistors 622-628 provide static voltage drop with the leakage current. This static drop of 2*Vth ensures that cascoded NMOS transistors 614 and 616 and cascoded PMOS transistors 638 and 640 do not exceed the device voltage limits. The cascoded PMOS transistors 638 and 640 protect the pull-up PMOS transistors 642 and 644 from exceeding the device voltage limits. Similarly, cascoded NMOS transistors 618 and 620 protect the pull-down NMOS transistors 602 and 604 from exceeding the device voltage limits. The reference voltages (V33 and V66) generated by a reference voltage generator (e.g., reference voltage generator 106 of FIG. 1) are supplied for inverters 658 and 560. High leakage of the inverters 658 and 560 may change the steady state value of references. In some implementations, device stacking may be done to decrease the leakage of the inverters 658 and 560.

In active mode, a gate of the NMOS transistor 602 receives a signal having the input voltage VIN that is set to VDDC and a gate of the NMOS transistor 604 receives a signal having the input_b voltage (VINB) that is set to zero. The NMOS transistor 602 is turned ON and discharges the node “a” to zero. The NMOS transistor 604 is turned OFF. The gates of the cascoded NMOS transistors 614 and 616 receive an enable signal having the enable voltage VEN that is set to V45. The NMOS transistors 614 have enough gate-source voltage (Vgs) to discharge the node “c” to zero, which in-turn discharges the node “d" to zero as NMOS transistor 618 has Vgs=V45.

The diode-connected PMOS transistors 622-628 have a static drop of 2*Vth such that the node “i” is discharged to 2*Vth from its previous value of 1.8V. This static drop of 2*Vth ensures that transistors 618, 620, 638 and 640 to not exceed their device voltage limits. The diode-connected NMOS transistors 630-636 are connected parallel to the diode-connected PMOS transistors 622-628 such that delays are reduced. For example, by using only one type of diode-connected transistors will increase the static drop across these diode-connected transistors which can in-turn cause higher delay.

The PMOS transistor 638 acts as a protection device to ensure that the node “j" doesn’t discharge beyond V55. V55 is set to 0.55*VDD18. In some implementations, the node “j" is discharged to a value close to V55, which in-turn turns ON the PMOS transistor and the node “k" is charged to VDD18. The PMOS transistor 640 pulls the node “l" to VDD18, which charges the node “m" to VDD18 - 2*Vth. The NMOS transistor 620 acts as a protection device, which ensures that the node “n" doesn’t charge beyond V45. In some implementations, the node “n" is charged close to V45. Similarly, the value of node “o" is also set by the leakage through the NMOS transistor 616 to a voltage V45-Vth as the NMOS transistor 604 is turned OFF. The NMOS transistors 606 and 608 are turned OFF as SET and RESET are both set to zero in the active mode. The inverters 658 and 660 then generate the final output signals based on these voltage levels.

In the illustrated implementation, in the active mode, the nodes a, c, d, m, n, o, and q are set to 0V, the nodes i and l are set to 0.25V, the nodes j and k are set to 0.99V, and the node p is set to 1.2V.

In power-down (PD) mode, the circuit operation is reversed. The gate of the NMOS transistor 602 receives a signal having the input voltage VIN that is set to zero and the gate of the NMOS transistor 604 receives a signal having the input_b voltage VINB that is set to VDDC. The gates of the cascoded NMOS transistors 614 and 616 receive an enable signal having the enable voltage VEN that is set to zero. The inverters 658 and 660 then generate the final output signals based on these voltage levels.

In the illustrated implementation, in the PD mode, the nodes a, c, n, and o are set to 0.81V, the nodes d and m are set to 1.53V, the nodes i, j, k, l, and p are set to 1.8V, and the node q is set to 0.6V.

Throughout both modes, the level shifter 600 maintains voltage levels across all devices within the safe operating range of 0.96V, allowing for stress-free operation for thin-oxide devices in a 1.8V supply environment. In some implementations, the level shifter 600 may support an input clock frequency up to 100 MHz and may consume about 40 μW of power without degrading the performance.

In the implementation illustrated in FIG. 6, each of the transistors 602-656 is configured as a single transistor. In other implementations, each of the transistors 602-656 may be configured as a stack of transistors. In such implementations, the stack of transistors may be connected in series or in parallel.

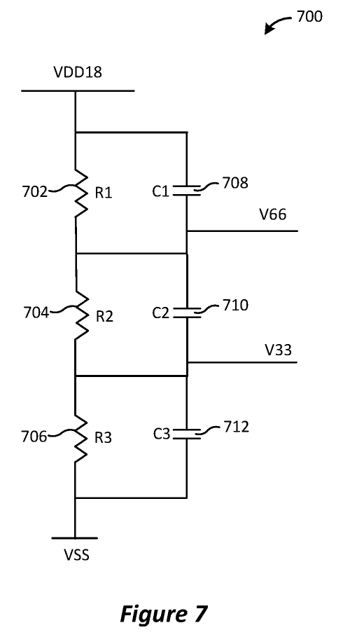

FIG. 7 illustrates a schematic of a reference voltage generator 700, in accordance with some implementations. In an implementation, the reference voltage generator 106 of the LDO voltage regulator system 100 (see FIG. 1) is implemented by the reference voltage generator 700. In the illustrated implementation, the reference voltage generator 700 is a passive RC ladder comprising a resistive ladder and a capacitive ladder. The resistive ladder comprises resistors 702-706 and ensures stable intermediate voltages during DC conditions. The capacitive ladder comprises capacitors 708-712 and supports transient current requirements. The reference voltage generator 700 is configured to generate reference voltages V33 and V66. V33 is 0.33*VDD18 and V66 is 0.66*VDD18.

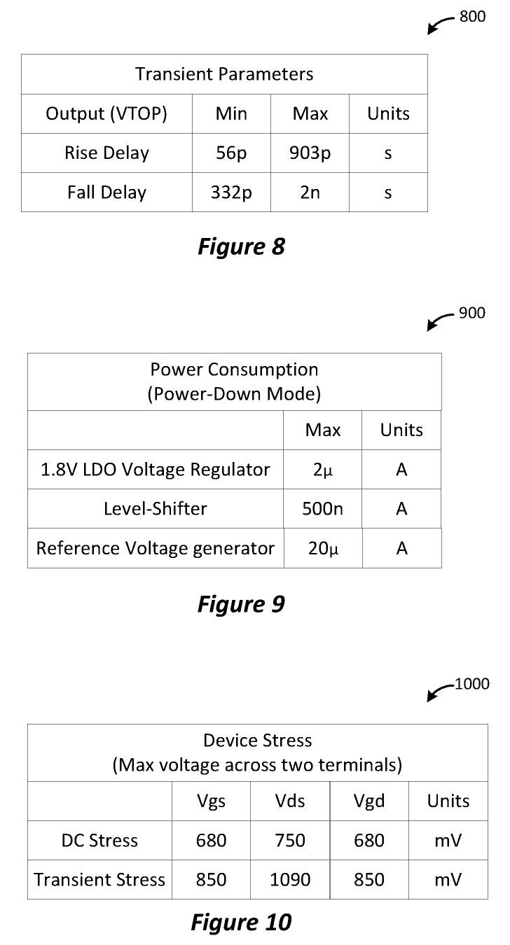

FIG. 8 illustrates a table 800 of delay results for a level shifter when implemented by the level shifter 600 (see FIG. 6) . The delay results may be obtained by simulating the level shifter 600 across all process, voltage, and temperature (PVT) corners. The table 800 shows simulation results for transient parameters such as rise delay and fall delay of the top voltage VTOP generated by the level shifter 600. The level shifter 600 has a maximum rise delay of 903 picoseconds (ps) and a maximum fall delay of 2 nanoseconds (ns) of the top voltage VTOP, with a maximum delay sigma variation of only 63 ps. Furthermore, the level shifter 600 has a minimum rise delay of 56 ps and a minimum fall delay of 332 ps of the top voltage VTOP.

FIG. 9 illustrates a table 900 of power consumption results for the LDO voltage regulator system 100 (see FIG. 1), in accordance with some implementations. The power consumption results shown in table 900 are representative examples of an implementation when the LDO voltage regulator 108 (see FIG. 1) of the LDO voltage regulator system 100 is implemented by the LDO voltage regulator 200 (see FIG. 2), the level shifter 104 (see FIG. 1) of the LDO voltage regulator system 100 is implemented by the level shifter 600 (see FIG. 6), and the reference voltage generator 106 (see FIG. 1) of the LDO voltage regulator system 100 is implemented by the reference voltage generator 700 (see FIG. 7). The power consumption results may be obtained by simulating the LDO voltage regulator system 100 across all PVT corners.

In the illustrated implementation, the LDO voltage regulator system 100 consumes a maximum current of 22.5 microamperes (μA). The majority of the current consumption, 20 μA, is attributed to the reference voltage generator 106, while the LDO voltage regulator 108 consumes a maximum current of 2 μA and level shifter 104 consumes a maximum current of 500 nanoamperes (nA).

FIG. 10 illustrates a table 1000 of reliability results for the LDO voltage regulator system 100 (see FIG. 1), in accordance with some implementations. The reliability results shown in the table 1000 are representative examples of an implementation when the LDO voltage regulator 108 (see FIG. 1) of the LDO voltage regulator system 100 is implemented by the LDO voltage regulator 200 (see FIG. 2), the level shifter 104 (see FIG. 1) of the LDO voltage regulator system 100 is implemented by the level shifter 600 (see FIG. 6), and the reference voltage generator 106 (see FIG. 1) of the LDO voltage regulator system 100 is implemented by the reference voltage generator 700 (see FIG. 7). The power consumption results may be obtained by simulating the LDO voltage regulator system 100 (see FIG. 1) across all PVT corners.

In the illustrated implementation, a maximum DC gate-source voltage (Vgs) is 680 mV, a maximum DC drain-source voltage (Vds) is 750 mV, a maximum DC gate-drain voltage (Vdg) is 680 mV, a maximum AC gate-source voltage (Vgs) is 850 mV, a maximum AC drain-source voltage (Vds) is 1090 mV, and a maximum AC gate-drain voltage (Vdg) is 850 mV. The simulation results show that the maximum DC voltage across any device in the circuit is less than 0.75 V, which is well within the safe operating range for the thin-oxide devices, which have a stress limit of 0.96 V. The design maintains a safety margin of 210 mV below this stress limit. This substantial margin ensures that even under worst-case conditions or slight variations in manufacturing or operating parameters, the devices will remain protected from overvoltage stress.

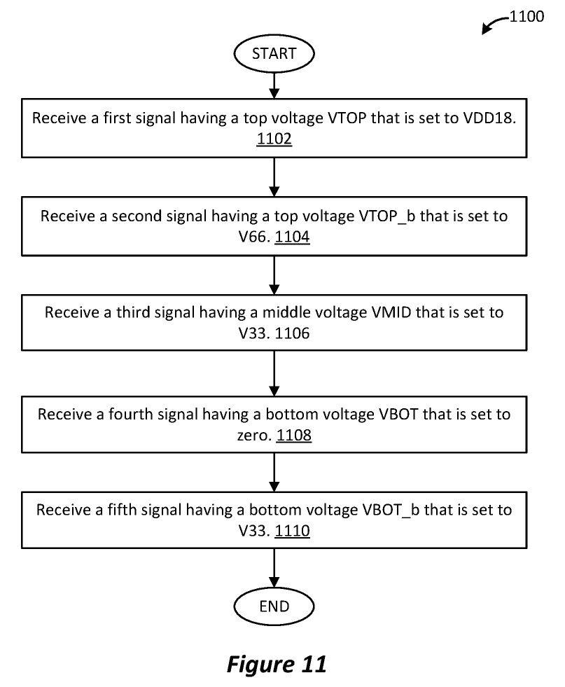

FIG. 11 illustrates a flowchart of a method 1100 for operating a low-dropout regulator in active mode, in accordance with some implementations. The method 1100 starts with step 1102 when the low-dropout voltage regulator (e.g., LDO voltage regulator 200 of FIG. 2) receives a first signal having a top voltage VTOP that is set to VDD18. In step 1104, the low-dropout voltage regulator (e.g., LDO voltage regulator 200 of FIG. 2) receives a second signal having a top voltage VTOP_b that is set to V66. In step 1106, the low-dropout voltage regulator (e.g., LDO voltage regulator 200 of FIG. 2) receives a third signal having a middle voltage VMID that is set to V33. In step 1108, the low-dropout voltage regulator (e.g., LDO voltage regulator 200 of FIG. 2) receives a fourth signal having a bottom voltage VBOT that is set to zero. In step 1110, the low-dropout voltage regulator (e.g., LDO voltage regulator 200 of FIG. 2) receives a fifth signal having a bottom voltage VBOT_b that is set to V33. In some implementations, the first, second, third, fourth and fifth signals are generated by a level shifter (e.g., level shifter 600 of FIG. 6) and are received by the low-dropout voltage regulator (e.g., LDO voltage regulator 200 of FIG. 2) at the same time.

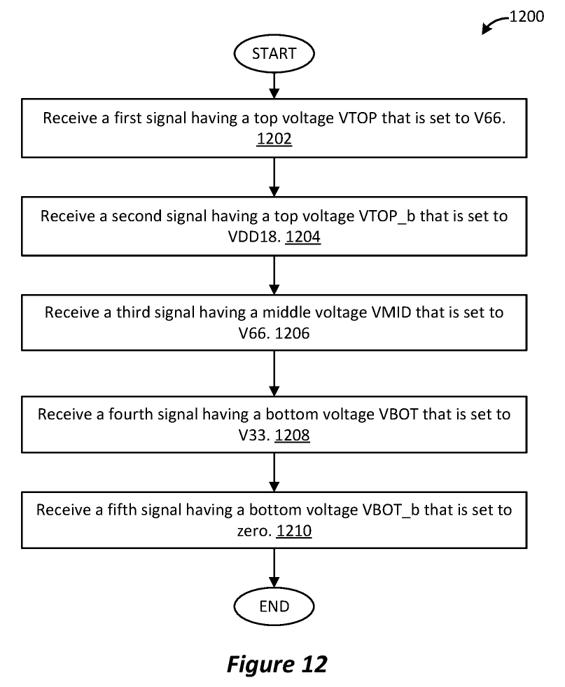

FIG. 12 illustrates a flowchart of a method 1200 for operating a low-dropout regulator in power-down (PD) mode, in accordance with some implementations. The method 1200 starts with step 1202 when the low-dropout voltage regulator (e.g., LDO voltage regulator 200 of FIG. 2) receives a first signal having a top voltage VTOP that is set to V66. In step 1204, the low-dropout voltage regulator (e.g., LDO voltage regulator 200 of FIG. 2) receives a second signal having a top voltage VTOP_b that is set to VDD18. In step 1206, the low-dropout voltage regulator (e.g., LDO voltage regulator 200 of FIG. 2) receives a third signal having a middle voltage VMID that is set to V66. In step 1208, the low-dropout voltage regulator (e.g., LDO voltage regulator 200 of FIG. 2) receives a fourth signal having a bottom voltage VBOT that is set to V33. In step 1210, the low-dropout voltage regulator (e.g., LDO voltage regulator 200 of FIG. 2) receives a fifth signal having a bottom voltage VBOT_b that is set to zero. In some implementations, the first, second, third, fourth and fifth signals are generated by a level shifter (e.g., level shifter 600 of FIG. 6) and are received by the low-dropout voltage regulator (e.g., LDO voltage regulator 200 of FIG. 2) at the same time.

In an implementation, a low-dropout voltage regulator includes: an output stage including a first transistor, a second transistor and a third transistor coupled in series, where the first transistor, the second transistor, and the third transistor are configured to operate at operating voltages that are less than or equal to a power supply voltage of the low-dropout voltage regulator, where: during an active mode: a first control node of the first transistor is configured to be set at a first operating voltage; a second control node of the second transistor is configured to be set at a second operating voltage, where the second operating voltage is different from the first operating voltage; and a third control node of the third transistor is configured to be set at a third operating voltage, where the third operating voltage has a same value as the second operating voltage; and during a power-down mode: the first control node of the first transistor is configured to be set at a fourth operating voltage, where the fourth operating voltage has a same value as the second operating voltage; the second control node of the second transistor is configured to be set at a fifth operating voltage, where the fifth operating voltage is lower than the second operating voltage; and the third control node of the third transistor is configured to be set at a sixth operating voltage, where the sixth operating voltage has a same value as the second operating voltage. In an implementation, the low-dropout voltage regulator further includes an error amplifier stage coupled to the output stage, the error amplifier stage including a fourth transistor, a fifth transistor and a sixth transistor, where the fourth transistor, the fifth transistor, and the sixth transistor are configured to operate at operating voltages that are less than or equal to the power supply voltage of the low-dropout voltage regulator. In an implementation, the low-dropout voltage regulator further includes a bias stage coupled to the error amplifier stage, the bias stage including a seventh transistor, an eighth transistor and a ninth transistor, where the seventh transistor, the eighth transistor, and the ninth transistor are configured to operate at operating voltages that are less than or equal to the power supply voltage of the low-dropout voltage regulator. In an implementation, the output stage is configured to be coupled to a level shifter, and the level shifter is configured to generate the first operating voltage, the second operating voltage, the fourth operating voltage, and the fifth operating voltage. In an implementation, the output stage is configured to be coupled to a reference voltage generator, and the reference voltage generator is configured to generate the third operating voltage and the sixth operating voltage. In an implementation, the first transistor, the second transistor and the third transistor have a stress limit of 0.96V. In an implementation, the power supply voltage is in a range from 1.62 V to 1.98 V. In an implementation, each of the first transistor, the second transistor, and the third transistor is configured as a stack of transistors connected in series. In an implementation, each of the first transistor, the second transistor, and the third transistor is configured as a stack of transistors connected in parallel.

In another implementation, a system includes: a level shifter configured to generate a first signal having a first operating voltage and a second signal having a second operating voltage based on a control signal; a reference voltage generator coupled to the level shifter, where the reference voltage generator is configured to generate a third signal having a third operating voltage; and a low-dropout regulator coupled to the level shifter and the reference voltage generator, the low-dropout regulator including an output stage, where the output stage includes a first transistor configured to receive the first signal from the level shifter, a second transistor configured to receive the second signal from the level shifter, and a third transistor configured to receive the third signal from the reference voltage generator, and where the second transistor and the third transistor act as cascode transistors. In an implementation, during an active mode: the first operating voltage has a first value; the second operating voltage has a second value different from the first value; and the third operating voltage has the second value. In an implementation, during a power-down mode: the first operating voltage has the second value; the second operating voltage has a third value different from the first value and the second value; and the third operating voltage has the second value. In an implementation, no current flows through the output stage during the power-down mode. In an implementation, the low-dropout regulator, the level shifter and the reference voltage generator are biased by a power supply voltage. In an implementation, the first operating voltage, the second operating voltage and the third operating voltage are less than or equal to the power supply voltage. In an implementation, the first value is same as the power supply voltage, the second value is less than the power supply voltage, and the third value is less than the power supply voltage.

In yet another implementation, a method of operating a low-dropout regulator, the low-dropout regulator including output stage, where the output stage includes a first transistor configured to receive a first signal having a first operating voltage from a level shifter, a second transistor configured to receive a second signal having a second operating voltage from the level shifter, and a third transistor configured to receive a third signal having a third operating voltage from a reference voltage generator, the method including: receiving, by a first control node of the first transistor, the first signal from the level shifter; receiving, by a second control node of the second transistor, the second signal from the level shifter; and receiving, by a third control node of the third transistor, the third signal from the reference voltage generator. In an implementation, the low-dropout regulator, the level shifter and the reference voltage generator are biased by a power supply voltage. In an implementation, during an active mode: the first operating voltage has a first value equal to the power supply voltage; the second operating voltage has a second value less than the power supply voltage; and the third operating voltage has the second value. In an implementation, during a power-down mode: the first operating voltage has the second value; the second operating voltage has a third value less than the power supply voltage, where the third value is different from the second value; and the third operating voltage has the second value. In an implementation, the second value is equal to 0.66 times the power supply voltage and the third value is equal to 0.33 times the power supply voltage. In an implementation, the first transistor, the second transistor and the third transistor have a stress limit of 0.96V. In an implementation, each of the first transistor, the second transistor, and the third transistor is configured as a stack of transistors connected in series. In an implementation, each of the first transistor, the second transistor, and the third transistor is configured as a stack of transistors connected in parallel.

While the present disclosure has been described with reference to illustrative implementations, this description is not intended to be construed in a limiting sense. Various modifications and combinations of the illustrative implementations, as well as other implementations of the present disclosure, will be apparent to persons skilled in the art upon reference to the description. It is therefore intended that the appended claims encompass any such modifications or implementations.

What is claimed is:

1. A low-dropout voltage regulator comprising:
an output stage comprising a first transistor, a second transistor and a third transistor coupled in series, wherein the first transistor, the second transistor, and the third transistor are configured to operate at operating voltages that are less than or equal to a power supply voltage of the low-dropout voltage regulator, wherein:
during an active mode:
a first control node of the first transistor is configured to be set at a first operating voltage;
a second control node of the second transistor is configured to be set at a second operating voltage, wherein the second operating voltage is different from the first operating voltage; and
a third control node of the third transistor is configured to be set at a third operating voltage, wherein the third operating voltage has a same value as the second operating voltage; and
during a power-down mode:
the first control node of the first transistor is configured to be set at a fourth operating voltage, wherein the fourth operating voltage has a same value as the second operating voltage;
the second control node of the second transistor is configured to be set at a fifth operating voltage, wherein the fifth operating voltage is lower than the second operating voltage; and
the third control node of the third transistor is configured to be set at a sixth operating voltage, wherein the sixth operating voltage has a same value as the second operating voltage.

2. The low-dropout voltage regulator of claim 1, further comprising an error amplifier stage coupled to the output stage, the error amplifier stage comprising a fourth transistor, a fifth transistor and a sixth transistor, wherein the fourth transistor, the fifth transistor, and the sixth transistor are configured to operate at operating voltages that are less than or equal to the power supply voltage of the low-dropout voltage regulator.

3. The low-dropout voltage regulator of claim 2, further comprising a bias stage coupled to the error amplifier stage, the bias stage comprising a seventh transistor, an eighth transistor and a ninth transistor, wherein the seventh transistor, the eighth transistor, and the ninth transistor are configured to operate at operating voltages that are less than or equal to the power supply voltage of the low-dropout voltage regulator.

4. The low-dropout voltage regulator of claim 1, wherein the output stage is configured to be coupled to a level shifter, and the level shifter is configured to generate the first operating voltage, the second operating voltage, the fourth operating voltage, and the fifth operating voltage.

5. The low-dropout voltage regulator of claim 1, wherein the output stage is configured to be coupled to a reference voltage generator, and the reference voltage generator is configured to generate the third operating voltage and the sixth operating voltage.

6. The low-dropout voltage regulator of claim 1, wherein each of the first transistor, the second transistor, and the third transistor is configured as a stack of transistors connected in series.

7. The low-dropout voltage regulator of claim 1, wherein each of the first transistor, the second transistor, and the third transistor is configured as a stack of transistors connected in parallel.

8. A system comprising:
a level shifter configured to generate a first signal having a first operating voltage and a second signal having a second operating voltage based on a control signal;
a reference voltage generator coupled to the level shifter, wherein the reference voltage generator is configured to generate a third signal having a third operating voltage; and
a low-dropout regulator coupled to the level shifter and the reference voltage generator, the low-dropout regulator comprising an output stage, wherein the output stage comprises a first transistor configured to receive the first signal from the level shifter, a second transistor configured to receive the second signal from the level shifter, and a third transistor configured to receive the third signal from the reference voltage generator, and wherein the second transistor and the third transistor act as cascode transistors.

9. The system of claim 8, wherein, during an active mode:
the first operating voltage has a first value;
the second operating voltage has a second value different from the first value; and
the third operating voltage has the second value.

10. The system of claim 9, wherein, during a power-down mode:
the first operating voltage has the second value;
the second operating voltage has a third value different from the first value and the second value; and
the third operating voltage has the second value.

11. The system of claim 10, wherein no current flows through the output stage during the power-down mode.

12. The system of claim 10, wherein the low-dropout regulator, the level shifter and the reference voltage generator are biased by a power supply voltage.

13. The system of claim 12, wherein the first operating voltage, the second operating voltage and the third operating voltage are less than or equal to the power supply voltage.

14. The system of claim 13, wherein the first value is same as the power supply voltage, the second value is less than the power supply voltage, and the third value is less than the power supply voltage.

15. A method of operating a low-dropout regulator, the low-dropout regulator comprising output stage, wherein the output stage comprises a first transistor configured to receive a first signal having a first operating voltage from a level shifter, a second transistor configured to receive a second signal having a second operating voltage from the level shifter, and a third transistor configured to receive a third signal having a third operating voltage from a reference voltage generator, the method comprising:
receiving, by a first control node of the first transistor, the first signal from the level shifter;
receiving, by a second control node of the second transistor, the second signal from the level shifter; and
receiving, by a third control node of the third transistor, the third signal from the reference voltage generator.

16. The method of claim 15, wherein the low-dropout regulator, the level shifter and the reference voltage generator are biased by a power supply voltage.

17. The method of claim 16, wherein, during an active mode:
the first operating voltage has a first value equal to the power supply voltage;
the second operating voltage has a second value less than the power supply voltage; and
the third operating voltage has the second value.

18. The method of claim 17, wherein, during a power-down mode:
the first operating voltage has the second value;
the second operating voltage has a third value less than the power supply voltage, wherein the third value is different from the second value; and
the third operating voltage has the second value.

19. The method of claim 18, wherein each of the first transistor, the second transistor, and the third transistor is configured as a stack of transistors connected in series.

20. The method of claim 15, wherein each of the first transistor, the second transistor, and the third transistor is configured as a stack of transistors connected in parallel.
